(19) United States
(12) Patent Application Publication
(10) Pub. No.: US 2024/0331020 A1
(43) Pub. Date: Oct. 3, 2024

(54) FITTING ROOM SYSTEM, FITTING METHOD, AND NON-TRANSITORY COMPUTER READABLE MEDIUM

(71) Applicant: NEC Corporation, Tokyo (JP)

(72) Inventor: Yuta Matsuoka, Tokyo (JP)

(73) Assignee: NEC Corporation, Tokyo (JP)

(21) Appl. No.: 18/612,077

(22) Filed: Mar. 21, 2024

(30) Foreign Application Priority Data
Apr. 3, 2023 (JP) 2023-059959

(51) Int. Cl. G06Q 30/0601; G06T 7/70; G06T 19/00; G06V 40/16

(52) U.S. Cl. CPC G06Q 30/0643; G06T 7/70; G06T 19/00; G06T 2207/30196; G06V 40/172

(57) ABSTRACT

A fitting room system includes an authentication control unit that authenticates a user in order to log in to the VR space in a fitting room of the real store, a display control unit that displays an avatar in the VR space for the user on a monitor in the fitting room when the authentication is successful, a product determination unit that detects and determines an offline physical product being worn by the user in the fitting room and to be sold at the real store, and a reflection unit that reflects, on the avatar displayed on the monitor, a digital item in the VR space or an online physical product to be sold at an online shop of the real store, which is associated to or similar to the determined offline physical product.

### INCORPORATION BY REFERENCE

This application is based upon and claims the benefit of priority from Japanese patent application No. 2023-59959, filed on Apr. 3, 2023, the disclosure of which is incorporated herein in its entirety by reference.

### TECHNICAL FIELD

The present disclosure relates to a fitting room system, a fitting method, and a program.

### BACKGROUND ART

A platform that can buy and sell a digital item and a physical product in a virtual reality (VR) space, such as a metaverse, has appeared. There is also a case where a well-known brand having a real store operates a virtual shop in the VR space on such a platform.

International Patent Publication No. WO2021/261188 discloses a technique for causing an avatar of a user to try on clothes in a virtual space. Japanese Unexamined Patent Application Publication No. 2020-119156 discloses a technique for estimating a physical characteristic of a user, based on peripheral information related to clothes to be worn by a user, and generating an avatar.

### SUMMARY

Against such a background, an advantage of a real store is gradually being lost. In the real store, a place where a VR space can be experienced is required.

The present disclosure has been made in order to solve such a problem, and an example object of the present disclosure is to provide a fitting room system and the like being capable of providing a user experience in a VR space even in a real store.

In a first example aspect of the present disclosure, a fitting room system includes:
an authentication control unit configured to authenticate a user in order to log in to a VR space in a fitting room of a real store;
a display control unit configured to display an avatar in a VR space for the user on a monitor in the fitting room when authentication is successful;
a product determination unit configured to detect and determine an offline physical product being worn by the user in the fitting room and to be sold at the real store; and
a reflection unit configured to reflect, on the avatar displayed on the monitor, a digital item in a VR space or an online physical product to be sold at an online shop of the real store, which is associated to or similar to the determined offline physical product.

In a second example aspect of the present disclosure, a fitting method includes:
authenticating a user in order to log in to a VR space in a fitting room of a real store;
displaying an avatar in a VR space for the user on a monitor in the fitting room when authentication is successful;
detecting and determining an offline physical product being worn by the user in the fitting room and to be sold at the real store; and
reflecting, on the avatar displayed on the monitor, a digital item in a VR space or an online physical product to be sold at an online shop of the real store, which is associated to or similar to the determined offline physical product.

In a third example aspect of the present disclosure, a program causes a computer to execute:
authenticating a user in order to log in to a VR space in a fitting room of a real store;
displaying an avatar in a VR space for the user on a monitor in the fitting room when authentication is successful;
detecting and determining an offline physical product being worn by the user in the fitting room and to be sold at the real store; and
reflecting, on the avatar displayed on the monitor, a digital item in a VR space or an online physical product to be sold at an online shop of the real store, which is associated to or similar to the determined offline physical product.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration example of a fitting room system according to a first example embodiment;

FIG. 2 is a flowchart describing a fitting method according to the first example embodiment;

FIG. 3 is a diagram describing an overview of a fitting room system according to some example embodiments;

FIG. 4 is a block diagram illustrating a configuration example of a management server of a fitting room system according to a second example embodiment;

FIG. 5 is a diagram describing an overall configuration of the fitting room system according to the second example embodiment;

FIG. 6 is a diagram describing a face authentication process in the fitting room system according to the second example embodiment;

FIG. 7 is a diagram describing a product determination process in the fitting room system according to the second example embodiment;

FIG. 8 is a diagram describing a pose estimation process in the fitting room system according to the second example embodiment; and

FIG. 9 is a diagram describing a feedback reception process from another user in the fitting room system according to the second example embodiment.

### EXAMPLE EMBODIMENT

### First Example Embodiment

Hereinafter, an example embodiment will be described with reference to the drawings.

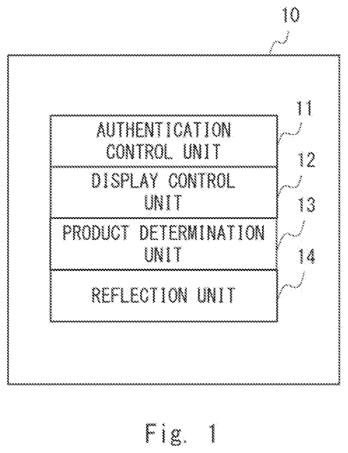

FIG. 1 is a block diagram illustrating a configuration example of a fitting room system according to a first example embodiment. The fitting room system uses a fitting room in a real store as an entrance to a VR space. A fitting room in a real store is basically a private space in which a customer is not seen by others. Thus, it is possible to acquire, for a store, an opportunity to sell a physical product and a digital item while giving consideration to protection of personal information (e.g., avatar information, and purchase information such as an address and a payment account) of a customer. The fitting room system may be achieved by one or more computers including a processor, a memory, a communication interface, and the like, and a monitor. As illustrated in FIG. 1, a fitting room system 10 includes an authentication control unit 11, a display control unit 12, a product determination unit 13, and a reflection unit 14.

The authentication control unit 11 authenticates a user in order to log in to a VR space in a fitting room of a real store. As an authentication method, various methods such as face authentication, biological authentication, and password authentication can be used. For example, in a case of face authentication, a face image (authentication information) of a user may be acquired by a camera disposed in the fitting room, and it may be performed based on whether the face image matches a face image of the user registered in advance. In a case of password authentication, it may be performed by a user inputting a user ID and a password (authentication information) by a communication terminal disposed in the fitting room.

When the authentication is successful, the display control unit 12 displays an avatar in the VR space for a user on a monitor in the fitting room. The monitor may be an entrance to the VR space. An avatar for a user is displayed on a monitor provided in the fitting room. The avatar for the user may be an avatar being set in advance by the user, or may be a similar avatar automatically generated based on a face image and a body image of the user captured by a camera.

The product determination unit 13 detects and determines an offline physical product being worn by a user in the fitting room and to be sold at the real store. As a product determination method, various methods can be used. One or more products being tried on may be determined, by an image search system, from a whole body image of a user who has tried on and captured by a camera in the fitting room. Alternatively, an RFID tag attached to a product may be read by a wireless reader, and thereby the product is determined. The offline physical product is a product being in stock at the real store, and can be brought into the fitting room by a user.

The reflection unit 14 reflects, on the avatar displayed on the monitor, a digital item in the VR space being associated to or similar to the determined offline physical product. A digital item is an item in the VR space, and may be mainly an item used by an avatar. A digital item in the VR space similar to an offline physical product may be a virtual product in the VR space, such as a different size product from an offline physical product, a different color product, or a new product or an old product of the same type.

Alternatively, the reflection unit 14 reflects, on the avatar displayed on the monitor, an online physical product being associated to or similar to the determined offline physical product and to be sold at an online shop of the real store. An online physical product similar to the determined offline physical product is a similar product (i.e., a different color product, a different size product, or a new product or an old product having the same model number) handled in the online shop of the real store, and may be, for example, a product having no stock in the real store.

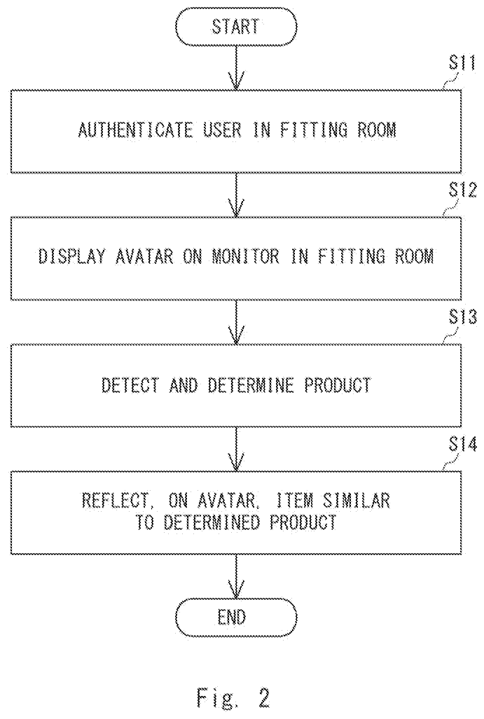

FIG. 2 is a flowchart illustrating a fitting method according to the first example embodiment.

The authentication control unit 11 authenticates a user (e.g., by using a camera, and an input apparatus such as a communication terminal or a keyboard) in order to log in to a VR space in a fitting room of a real store (step S11). When the authentication is successful, the display control unit 12 displays an avatar in the VR space for the user on a monitor in the fitting room (step S12). The product determination unit 13 detects and determines an offline physical product being worn by the user in the fitting room and to be sold at the real store (step S13). The reflection unit 14 reflects, on the avatar displayed on the monitor, a digital item in the VR space or an online physical product to be sold at an online shop of the real store, which is associated to or similar to the determined offline physical product (step S14).

According to the fitting room system and the fitting method according to the present example embodiment described above, it is possible to provide a user experience in a VR space even in a real store.

### Second Example Embodiment

A platform that can buy and sell a digital item and a physical product in a VR space, such as a metaverse, has been appeared. There also be a case where a well-known brand having a real store operates a virtual shop in the VR space. The virtual shop can be accessed from anywhere via a communication terminal, a network, and the like. There is a case where some well-known brands simultaneously release the same product in real and digital form. With popularization of a VR platform, demand for a digital item is expected to increase. As used in the present specification, a digital item refers to an item that an avatar uses in the VR space. The digital item may also be referred to as a virtual product.

Against such a background, an advantage of a real store is gradually being lost. A real store sells only a physical product such as clothes, but a virtual shop can sell not only a physical product but also, for example, a digital item available in the VR space such as clothes for an avatar. Further, although the number of physical products that can be stored in stock in a store is limited to a small number in the real store, in a case of an online shop, a large warehouse can be owned and a larger number of physical products can be handled. Note that, as used in the present specification, a physical product placed in a real store, a warehouse thereof, or the like may be referred to as an offline physical product or an offline product. Further, a physical product in which the online shop can handle may be referred to as an online physical product or an online product. Furthermore, the online physical product may overlap with the offline physical product, but in a general sales form, the number of products handled is larger than that of the offline physical product.

A real store can also sell the online physical product and the digital item via a communication terminal or the like. However, although a customer needs to associate with avatar information of the customer in the VR space at a real store, some customers may not want to disclose personal information to public. For example, an elderly man may not want to disclose that an avatar of a young woman is using. When a real store sells a digital item, it is necessary to be able to easily shop while associating avatar information of a customer with personal information, and to also take into consideration protection of such personal information.

A customer may be hesitant to purchase a digital item at a real store because the customer does not have an immersive feeling as in a case of purchasing the digital item while operating an avatar in the VR space. Further, a customer may also be hesitant to purchase an online physical product not being in stock at a real store without trying on.

Thus, the present disclosure proposes a fitting room system being capable of providing a user experience such as shopping by an avatar operation in the VR space while giving consideration to protection of personal information. Further, the present disclosure proposes a fitting room system integrating an offline fitting room in a real store and an online fitting room in the VR space.

Hereinafter, a specific example embodiment to which the present disclosure is applied will be described in detail with reference to the drawings. However, the present disclosure is not limited to the following example embodiment. Further, for clarity of description, the following description and the drawings are simplified as appropriate.

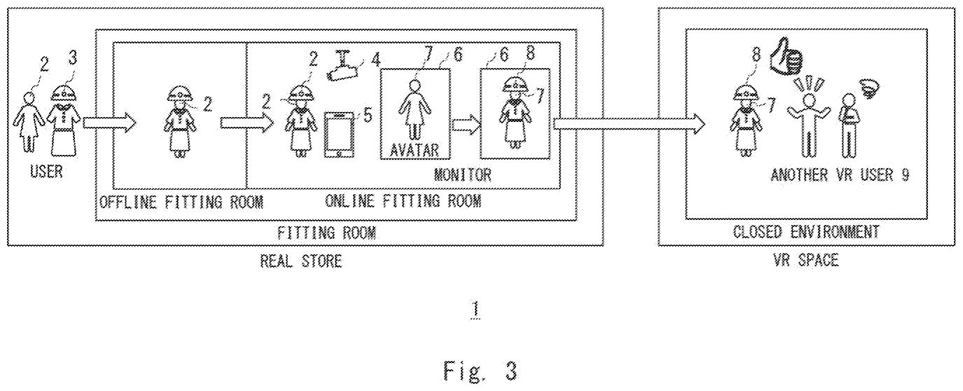

FIG. 3 is a diagram illustrating an overview of a fitting room system according to some example embodiments.

A user 2 visits a real store, brings a favorite physical product 3 (in the present example, a hat, a suit of clothes, and a skirt) to an offline fitting room (a fitting room of the real store), and tries on the brought product. The user 2 performs face authentication with a camera 4 in the offline fitting room before or after fitting. Note that, an authentication method other than the face authentication (e.g., password authentication, fingerprint authentication, and the like) can also be used. However, with the face authentication, a customer can more easily enjoy shopping. The face authentication may be performed by using a communication terminal 5 integrated with a camera. The communication terminal 5 is a computer terminal including a processor, a memory, a communication interface, and the like.

When a customer being the user 2 already has an own avatar on a VR platform, an avatar 7 associated with the user 2 is displayed on a monitor 6 installed in the offline fitting room or the like when the authentication is successful. Since some users who first use the VR platform do not have an avatar on the VR platform, a default avatar, an avatar similar to an attribute (e.g., age, gender, a body type, and the like) of the user, or any avatar selected by the user may be displayed. Note that, in the present example illustrated in the drawings, the avatar 7 of the user 2 is the same as or similar to a body type of the user 2. An avatar similar to the attribute of a user may be automatically generated from an image of the user captured by the camera 4.

By causing the camera 4 or the like to detect the physical product 3 (in the present example, a hat, a suit of clothes, and a skirt) that the user 2 is trying on, the avatar 7 that tries on a digital item 8 (in the present example, a digital item of each of a hat, a suit of clothes, and a skirt) being associated to or similar to the physical product 3 is displayed on the monitor 6. In some example embodiments, the avatar 7 having tried on the digital item 8 may be displayed on the monitor 6 by the user 2 operating the communication terminal 5 in such a way as to cause the avatar 7 to try on the digital item 8 (in the present example, a digital item of each of a hat, a suit of clothes, and a skirt).

Further, in some example embodiments, by causing the camera 4 or the like to detect the physical product 3 (in the present example, a hat, a suit of clothes, and a skirt) that the user 2 is trying on, the avatar 7 that tries on an online product (in the present example, an online product of each of a hat, a suit of clothes, and a skirt) being associated to or similar to the physical product 3 is displayed on the monitor 6. A similar online product is, for example, a different color product or a different size product. As a result, when there is no stock of a product at the real store, but there is stock of the product at another store or an online shop, a customer can cause an avatar to try on the product.

Further, a pose of the user 2 captured by the camera 4 may be estimated in real time, and reflected in a pose of the avatar 7 of the user 2. As a result, it is possible to provide a user experience such as shopping by an avatar operation in the VR space. Further, by integrating the offline fitting room for a customer in the real store with the online fitting room for an avatar in the VR space, it is possible to provide a purchase opportunity of not only the offline physical product but also the online physical product and the digital item while giving consideration to protection of the personal information.

The user 2 can acquire feedback (e.g., “like”, rating, an impression) from another user 9 (or an avatar thereof) in the VR space on the clothes that the avatar 7 tries on in the VR space. The another user 9 may be a user with a familiar relationship being set in advance by the user 2, that is, a friend or a family in a real life of the user 2. Further, anther user may also be another user in the VR space. The anther user 9 in the VR space may be, for example, a VR user in a closed environment in the VR space (e.g., a special stage such as a fashion show operated by a dealer or an affiliate company thereof) operated by a dealer or an affiliate company thereof that sells both the physical product 3 and the digital item 8. As a result, the dealer or the affiliate company thereof can acquire an advertising effect of the digital item in the VR space or the physical product through a fashion show or the like in the VR space while giving consideration to protection of the personal information of a user.

According to the present example embodiment described above, it is possible to acquire an opportunity to sell not only a physical product but also a digital item at a real store. By integrating an offline real store and an online store, a user experience in the VR space can be provided, and thereby the number of newly participating users to the VR platform can be expanded. Furthermore, a user can easily and securely cause an avatar, at a real store, to try on a digital item for an avatar or an online product not being in stock at the real store, and buy it when the user likes it. Further, a user can interact with a user in the VR space through feedback to a tried-on avatar at the real store. The real store may also acquire an advertisement opportunity of a digital item for an avatar, an online product not being in stock at the real store, or the like through interaction between users in the VR space.

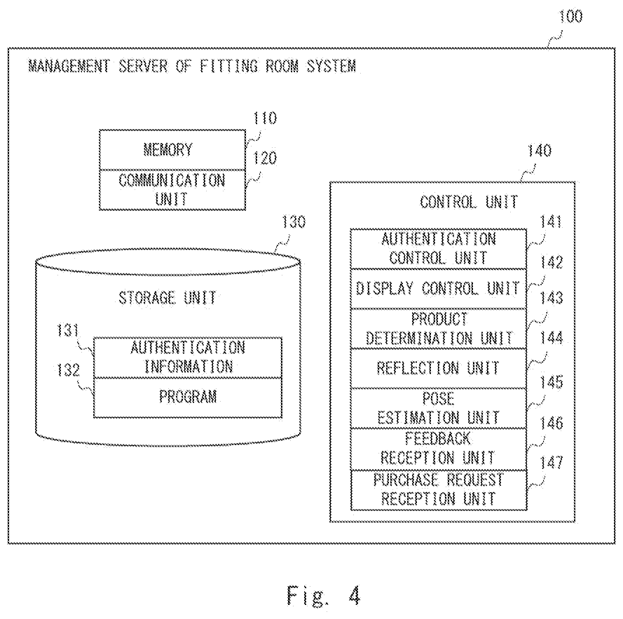

FIG. 4 is a block diagram illustrating a configuration example of a management server of the fitting room system.

The management server 100 includes a memory 110, a communication unit 120, a storage unit 130, and a control unit 140.

The memory 110 is a storage area temporarily storing a processing content of the control unit 140, and is, for example, a volatile storage apparatus such as a random access memory (RAM). The communication unit 120 is an interface performing communication with an outside of the management server 100. The storage unit 130 is a storage apparatus storing an authentication information 131, a program 132, and the like. The authentication information 131 may include, for example, face image information, biological authentication information, password authentication information (a user ID, and a password), and the like. The program 132 is a computer program on which a fitting method according to the present example embodiment is implemented.

The control unit 140 includes an authentication control unit 141, a display control unit 142, a product determination unit 143, a reflection unit 144, a pose estimation unit 145, a feedback reception unit 146, and a purchase request reception unit 147. The control unit 140 is a control apparatus controlling an operation of the management server 100, and is, for example, a processor such as a central processing unit (CPU). The control unit 140 reads the program 132 from the storage unit 130 into the memory 110, and executes the read program. As a result, the control unit 140 achieves functions as the authentication control unit 141, the display control unit 142, the product determination unit 143, the reflection unit 144, the pose estimation unit 145, the feedback reception unit 146, and the purchase request reception unit 147.

The authentication control unit 141 authenticates a user in order to log in to the VR space in a fitting room of a real store. As an authentication method, various methods such as biological authentication, face authentication, and password authentication can be used. In some example embodiments, the authentication control unit 141 can perform the face authentication by using a face image of a user captured by the camera 4 installed in the fitting room. As a result, a user can more easily log in to the VR space in the fitting room of the real store.

When the authentication is successful, the display control unit 142 displays an avatar in the VR space for a user on the monitor 6 in the fitting room. When a user (customer) already has an own avatar on the VR platform, the avatar 7 associated with the user 2 is displayed on the monitor 6 installed in an offline fitting room or the like when the authentication is successful. Since some first-time users may not have an avatar in the VR space, a default avatar, an avatar similar to an attribute (e.g., age, gender, a body type, and the like) of the user, or any avatar selected by the user may be displayed. An avatar similar to the attribute of a user may be automatically generated from an image of the user captured by the camera 4. Note that, in the present example illustrated in the drawings, the avatar 7 of the user 2 is the same as or similar to a body type of the user 2.

The product determination unit 143 detects and determines an offline physical product being worn by a user in the fitting room and to be sold at a real store. The product determination unit 143 can detect and determine an offline physical product being worn by a user from an image of an entire body of the user captured by the camera 4. The product determination unit 143 can also determine by reading, by using a wireless reader (RFID reader), a radio identification means such as an IC tag or an RF tag of an offline physical product being worn by a user.

The reflection unit 144 can reflect, on an avatar displayed on the monitor, a digital item in the VR space being associated to or similar to the determined offline physical product. Further, the reflection unit 144 can reflect, on the avatar displayed on the monitor, an online physical product being associated to or similar to the determined offline physical product and to be sold at an online shop of a real store. A user can view the avatar 7 wearing a digital item or an online physical product, and thereby determine whether to purchase the digital item or the online physical product.

The pose estimation unit 145 estimates a pose of a user captured by the camera 4 in the fitting room. The reflection unit 144 reflects the estimated pose of the user on the avatar 7 on the monitor. For example, the reflection unit 144 and the pose estimation unit 145 can also reflect a pose change of a user on the avatar 7 in such a way that the avatar 7 on the monitor turns around when the user turns around. Further, in some example embodiments, a change in a facial expression of a user may be reflected in a facial expression of an avatar.

The feedback reception unit 146 receives feedback (e.g., like, a comment, an impression) from another user in the VR space for an avatar reflecting a digital item or an online physical product. The another user may be a user with a familiar relationship (e.g., a friend, a family, or the like) being set in advance by a user. Further, in another example embodiment, the another user may be a user in a closed environment in the VR space operated by a dealer or an affiliate company thereof that sells both a physical product and a digital item.

The purchase request reception unit 147 receives a purchase request for purchasing a digital item or an online physical product from a user through a communication terminal provided in a real store, a user terminal carried by the user, or the like. A user can recognize the feedback, by the feedback reception unit 146 described above, from another user on an avatar reflecting a digital item or an online physical product through the monitor 6 (or a communication terminal or the like), and determine whether to purchase. When a user purchases a digital item, a settlement is performed, and thereafter, the purchased digital item can be carried and used in the VR space. When a user purchases an online physical product, a settlement is performed, and thereafter, delivery arrangement for the purchased online physical product to a customer's home, a real store, or the like is performed.

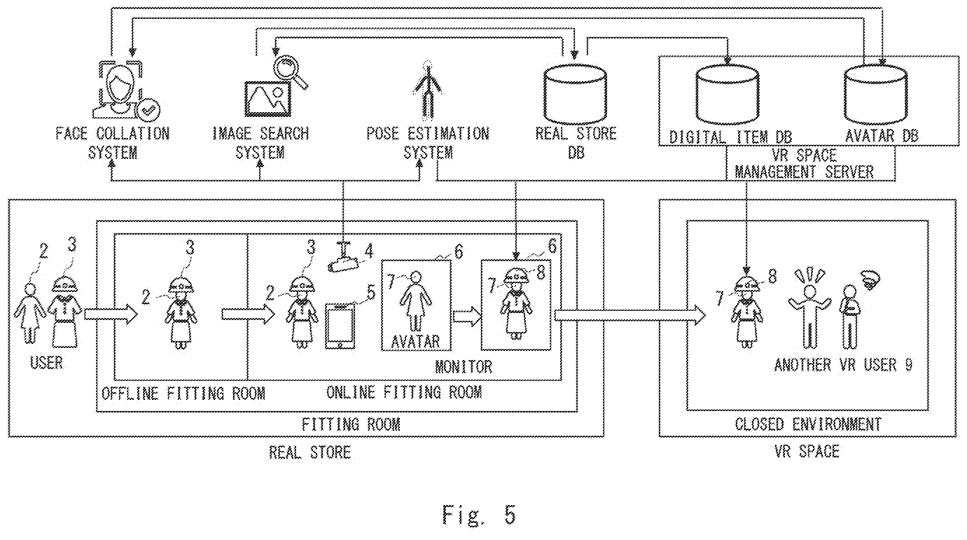

FIG. 5 is a diagram for describing an overall configuration of the fitting room system according to the second example embodiment.

The user 2 takes a favorite item 3 (in the present example, a hat, a suit of clothes, and a skirt) in a real store, and tries on the product in an offline fitting room. After trying on, the user 2 moves to a space (which may be an entrance to an online fitting room in the VR space) partitioned by a curtain or the like in the fitting room. The space is a private space not being seen by another customer or a clerk. Herein, the user 2 logs in to the VR space by using a camera 4 or the communication terminal 5. The fitting room system may include a face collation system, an image search system, and a pose estimation system. The fitting room system includes a real store DB that manages information such as stock of an offline product handled at the real store (and, in some example embodiments, although not illustrated, an online shop DB that manages information such as stock of an online product handled at an online shop of the real store). Further, when the real store is operating a virtual shop, the fitting room system may include an avatar database (DB) that manages avatar information on the VR platform, and a digital item DB that manages digital item information. Note that, a part of components of the management server 100 of the fitting room system described above may be implemented in the face collation system, the image search system, or the pose estimation system. Each of the management server 100 of the fitting room system, the face collation system, the image search system, and the pose estimation system may be achieved by separate computers connected to one another via a wired or wireless network.

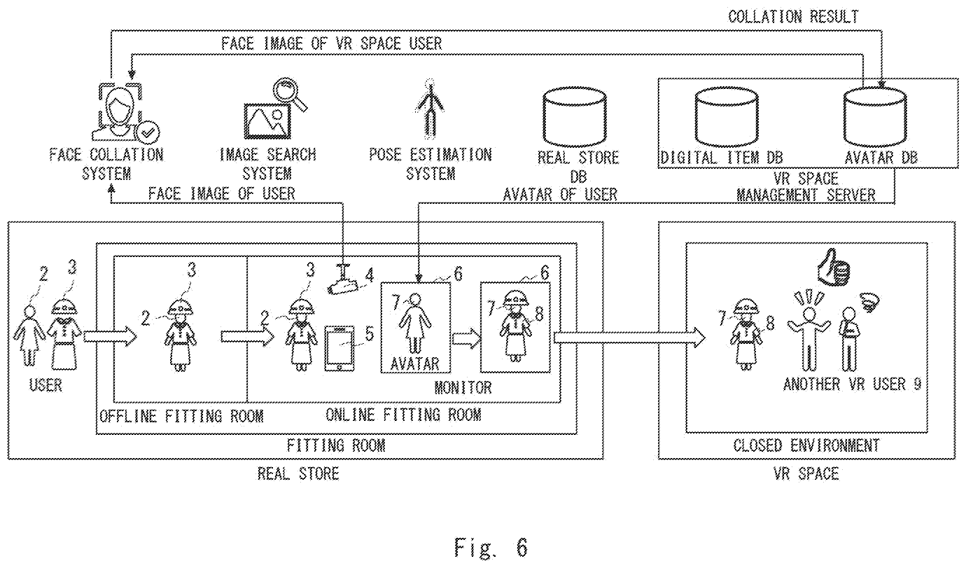

FIG. 6 is a diagram for describing a face authentication process in the fitting room system according to the second example embodiment.

When the user 2 is captured a face image with the camera 4 of the fitting room or the like, the face collation system acquires the face image of the user 2 from the camera 4 via a network. The face collation system collates the acquired face image (authentication information) of the user 2 with a registered face image of a VR user of a VR space management server. When the collation matches, the VR space management server acquires an avatar associated with the user from the avatar DB, and displays the avatar 7 of the user 2 on the monitor 6 of the fitting room.

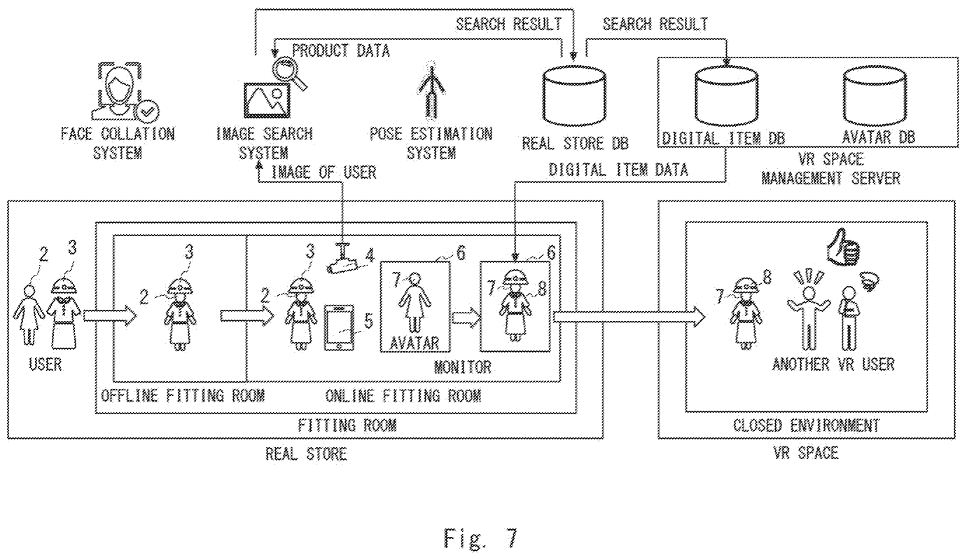

FIG. 7 is a diagram illustrating a product determination process in the fitting room system.

When an entire body of the user 2 is captured by the camera 4 in a state of wearing the physical product 3 (in the present example, a hat, a suit of clothes, and a skirt), the image search system acquires the captured whole body image of the user 2 via a network, and acquires information of the physical product 3 from the real store DB, based on the whole body image of the user 2. A known technique for recognizing an object and an image can be used. The image search system acquires digital item data in the VR space being associated to or similar to the determined offline physical product from the digital item DB. Further, the image search system acquires online physical product data being associated to or similar to the determined offline physical product and to be sold at an online shop of a real store. Thereafter, the reflection unit 144 of the management server 100 reflects, on the avatar 7 of the monitor 6, in such a way as to cause the avatar to try on the acquired digital item 8 or the online physical product.

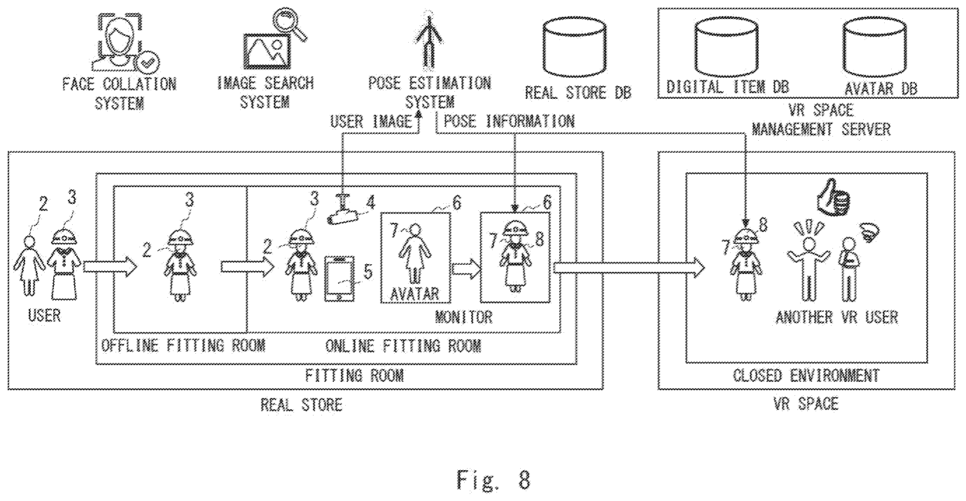

FIG. 8 is a diagram illustrating a pose estimation process in the fitting room system.

When the user 2 moves a body while wearing the physical product 3 in the fitting room, the pose estimation system acquires an image of the user 2 captured by the camera 4, and estimates a pose of the user 2. Specifically, the pose estimation system can extract skeleton information of at least a part of a body of a person, based on a characteristic such as a joint of the person recognized in a body image, by using a skeleton estimation technique using machine learning. Skeleton information is information configured by a “key point” being a characteristic point such as a joint, and a “bone (bone link)” indicating a link between the key points. The pose estimation system may use, for example, a skeleton estimation technique such as OpenPose.

The reflection unit 144 of the management server 100 can reflect on a pose of the avatar 7 in real time, based on pose change information of the user 2 estimated by the pose estimation system. For example, when the user 2 turns around in the fitting room, a pose change of the user 2 can also be reflected on the avatar 7 in such a way that the avatar 7 on the monitor 6 also turns around. Further, in a case where the user 2 moves the avatar 7 to the closed environment in the VR space by using the communication terminal 5 and receives feedback from another user, when the user 2 takes a predetermined pose in the fitting room, a pose change of the user 2 is reflected on the avatar 7 on the monitor 6 in such a way as to take a similar pose. In some example embodiments, a change in a facial expression of a user (e.g., smile) may be reflected on a facial expression of an avatar.

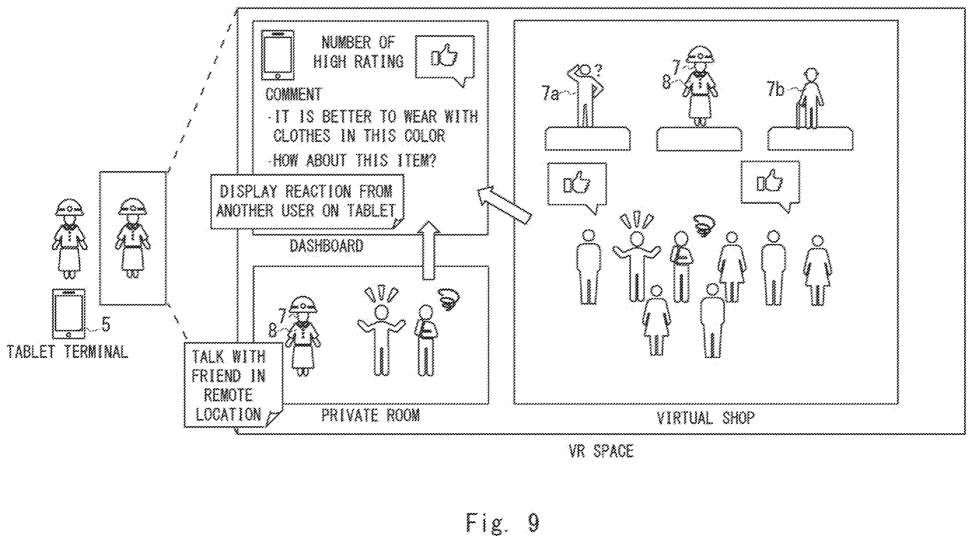

FIG. 9 is a diagram illustrating a feedback reception process from another user in the fitting room system.

A user may use the communication terminal 5 in the fitting room, and thereby receive feedback from another user about a digital item or an online physical item being worn by the avatar 7 in the closed environment in the VR space. As illustrated in FIG. 9, in a private room in the VR space, a user can communicate with another user (e.g., a friend or a family) being set in advance by the user via the communication terminal 5 (e.g., a tablet terminal). As a communication method, a voice call via the communication terminal 5 may be used, or a comment or like may be received on a dashboard with respect to the avatar 7 in the VR space. Examples of comments from another user include recommending a different color item of a digital item, recommending another item, and the like. A user can operate the communication terminal 5, and thereby perform processing such as changing clothes to another item on the avatar 7, changing a color or size of the item, or adding another item. Further, a user can purchase a digital item or an online physical product by operating the communication terminal 5.

In some example embodiments, a dealer or an affiliate company thereof selling a physical product and a digital item may also operate a virtual shop in the VR space. In the virtual shop, as illustrated in FIG. 9, the avatar 7 wearing the digital item 8 can stand on a special stage (dedicated stand) found by an audience being another user, and receive feedback from the another user. Further, the audience being the another user can view the avatar 7 wearing the digital item 8, and purchase the favorite digital item 8 by using a communication terminal of the another user. The communication terminal of the another user may be, for example, a computer, a smartphone, a head mounted display device, or the like. In the special stage, avatars 7a and 7b of other users, which are other than the avatar 7 of the user 2, who use a fitting room of another store being different from a fitting room of a store used by the user 2 may stand by wearing a digital item, an online product, and the like. Thus, protection of personal information such as a relationship between a user and an avatar can be ensured. The feedback may also include a comment (e.g., it is better to wear with clothes in this color, how about this item?) for the avatar 7 wearing the digital item 8. Note that, the audience being the another user may be a user in a closed environment in the VR space operated by a dealer or an affiliate company thereof selling a physical product and a digital item. As a result, the dealer or the like can acquire an advertising effect of the physical product or the digital item to be sold, through interaction with various users in the virtual shop while giving consideration to the protection of the personal information of a customer.

Although the present disclosure has been described as a hardware configuration in the above-described example embodiments, the present disclosure is not limited thereto. The present disclosure can also achieve any piece of processing by causing a central processing unit (CPU) to execute a computer program.

In the examples described above, a program includes an instruction group (or software code) that, when loaded into a computer, cause a computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that, the present disclosure is not limited to the above-described example embodiments, and can be appropriately modified without departing from the spirit.

Some or all of the above-described example embodiments may also be described as the following supplementary notes, but are not limited thereto.

### Supplementary Note 1

A fitting room system including:
an authentication control unit configured to authenticate a user in order to log in to a VR space in a fitting room of a real store;
a display control unit configured to display an avatar in a VR space for the user on a monitor in the fitting room when authentication is successful;
a product determination unit configured to detect and determine an offline physical product being worn by the user in the fitting room and to be sold at the real store; and
a reflection unit configured to reflect, on the avatar displayed on the monitor, a digital item in a VR space or an online physical product to be sold at an online shop of the real store, which is associated to or similar to the determined offline physical product.

### Supplementary Note 2

The fitting room system according to supplementary note 1, further including a purchase request reception unit configured to receive a purchase request for purchasing the digital item or the online physical product from a user, through a communication terminal provided in the real store or a communication terminal carried by the user.

### Supplementary Note 3

The fitting room system according to supplementary note 1, further including a feedback reception unit configured to receive feedback from another user in a VR space for the avatar reflecting the digital item or the online physical product.

### Supplementary Note 4

The fitting room system according to supplementary note 1, further including a pose estimation unit configured to estimate a pose of a user captured by a camera in real time,
wherein the reflection unit reflects the estimated pose of the user on the avatar on the monitor.

### Supplementary Note 5

The fitting room system according to supplementary note 1, wherein the authentication control unit authenticates the user, based on an image of a face of the user being captured by a camera provided in the real store.

### Supplementary Note 6

The fitting room system according to supplementary note 3, wherein the another user is a user with a familiar relationship being set in advance by the user.

### Supplementary Note 7

The fitting room system according to supplementary note 3, wherein the another user is a user in a closed environment in a VR space being operated by a dealer or an affiliate company thereof selling the physical product and the digital item.

### Supplementary Note 8

The fitting room system according to supplementary note 3, wherein the feedback includes a comment from the another user about the avatar reflecting the digital item or the online physical item.

### Supplementary Note 9

A fitting method including:
authenticating a user in order to log in to a VR space in a fitting room of a real store:
displaying an avatar in a VR space for the user on a monitor in the fitting room when authentication is successful;
detecting and determining an offline physical product being worn by the user in the fitting room and to be sold at the real store; and
reflecting, on the avatar displayed on the monitor, a digital item in a VR space or an online physical product to be sold at an online shop of the real store, which is associated to or similar to the determined offline physical product.

### Supplementary Note 10

A program causing a computer to execute:
authenticating a user in order to log in to a VR space in a fitting room of a real store;
displaying an avatar in a VR space for the user on a monitor in the fitting room when authentication is successful;
detecting and determining an offline physical product being worn by the user in the fitting room and to be sold at the real store; and
reflecting, on the avatar displayed on the monitor, a digital item in a VR space or an online physical product to be sold at an online shop of the real store, which is associated to or similar to the determined offline physical item.

An example advantage according to the present disclosure is to enable to provide a fitting room system or the like being capable of providing a user experience of a VR space even in a real store.

What is claimed is:

1. A fitting room system comprising:
at least one memory storing instructions, and
at least one processor configured to execute the instructions to;
authenticate a user in order to log in to a VR space in a fitting room of a real store;
display an avatar in a VR space for the user on a monitor in the fitting room when authentication is successful;
detect and determine an offline physical product being worn by the user in the fitting room and to be sold at the real store; and
reflect, on the avatar displayed on the monitor, a digital item in a VR space or an online physical product to be sold at an online shop of the real store, which is associated to or similar to the determined offline physical product.

2. The fitting room system according to claim 1, wherein the at least one processor configured to execute the instructions to receive a purchase request for purchasing the digital item or the online physical product from a user, through a communication terminal provided in the real store or a communication terminal carried by the user.

3. The fitting room system according to claim 1, wherein the at least one processor configured to execute the instructions to receive feedback from another user in a VR space for the avatar reflecting the digital item or the online physical product.

4. The fitting room system according to claim 1, wherein the at least one processor configured to execute the instructions to estimate a pose of a user captured by a camera in real time, and
reflect the estimated pose of the user on the avatar on the monitor.

5. The fitting room system according to claim 1, wherein the at least one processor configured to execute the instructions to authenticate the user, based on an image of a face of the user being captured by a camera provided in the real store.

6. The fitting room system according to claim 3, wherein the another user is a user having a familiar relationship being set in advance by the user.

7. The fitting room system according to claim 3, wherein the another user is a user in a closed environment in a VR space being operated by a dealer or an affiliate company thereof selling the physical product and the digital item.

8. The fitting room system according to claim 3, wherein the feedback includes a comment from the another user about the avatar reflecting the digital item or the online physical item.

9. A fitting method comprising:
authenticating a user in order to log in to a VR space in a fitting room of a real store;
displaying an avatar in a VR space for the user on a monitor in the fitting room when authentication is successful;
detecting and determining an offline physical product being worn by the user in the fitting room and to be sold at the real store; and
reflecting, on the avatar displayed on the monitor, a digital item in a VR space or an online physical product to be sold at an online shop of the real store, which is associated to or similar to the determined offline physical product.

10. A non-transitory computer readable medium storing a program causing a computer to execute:
authenticating a user in order to log in to a VR space in a fitting room of a real store;
displaying an avatar in a VR space for the user on a monitor in the fitting room when authentication is successful;
detecting and determining an offline physical product being worn by the user in the fitting room and to be sold at the real store; and
reflecting, on the avatar displayed on the monitor, a digital item in a VR space or an online physical product to be sold at an online shop of the real store, which is associated to or similar to the determined offline physical product.
